(19) United States
(12) Patent Application Publication
(10) Pub. No.: US 2022/0040825 A1
(43) Pub. Date: Feb. 10, 2022

(54) SOCKET WRENCH EXTENSION FOR USE WITH A RATCHET IN THE OIL FIELD

(71) Applicant: TERRY WHITTLETON, MEDICINE HAT (CA)

(72) Inventor: TERRY WHITTLETON, MEDICINE HAT (CA)

(21) Appl. No.: 17/279,029

(22) PCT Filed: Sep. 27, 2019
(86) PCT No.: PCT/CA2019/000136

§ 371 Date: Mar. 23, 2021

(30) Foreign Application Priority Data
Sep. 27, 2018 (CA) 3018874

(51) Int. Cl. B25B 13/46; B25B 23/00; B25B 13/48

(52) U.S. Cl. CPC B25B 13/46; E21B 33/06; B25B 13/48; B25B 23/0021

(57) ABSTRACT

There is described a socket extension member for use with a square drive ratchet to close and open the valves on a Ratigan style oil field wellhead blow-out preventer. The extension member comprises a solid shaft portion connected to a first end portion with a square bore to matingly receive the square drive ratchet wrench and a second end portion connected to the shaft portion opposite of the first end portion with a circular bore and an interior of the circular bore being fashioned to matingly and engage the end of the wellhead Ratigan style blowout preventer valve.

### BACKGROUND OF THE INVENTION

The present invention relates to a socket extension member that can incorporate an external ratchet. In particular, the present invention relates to a socket extension member for use in screwing in and unscrewing valves on a Ratigan style blow-out preventer used in an oil field wellhead.

Normally, a crescent wrench is used to screw in and unscrew the valves on a Ratigan style blow-out preventer in an oil field wellhead when it is necessary to change the packing within the blow-out preventer.

The disadvantages of using crescent wrenches are that they may slip off the valve, they require a great deal of strength and endurance to use and there may be insufficient room to use them within the confines of the wellhead structure.

Extensions have been designed to address such situations. For example, Pearce (U.S. Pat. No. 5,438,894), discloses a socket wrench extension in which a first end portion of the wrench has a hexagonal outside perimeter and a square inner perimeter. The hexagonal outside perimeter allows for a second wrench to provide extra torque to the extension. The extension further provides a lip near the hexagonal outside diameter to prevent a wrench from slipping down over the shank of the socket wrench when an external wrench is being used. Another example, Lewis (U.S. Pat. No. 5,568,757), also provides a socket wrench adapter having a hexagonal end having a square inner diameter. The adapter also has a lip that allows for a wrench to rest against.

It would be advantageous, however, to provide an improved extension specifically designed for use with the particular structure of a Ratigan style blow-out preventer within the confines of the construction of an oil field wellhead.

### SUMMARY OF THE INVENTION

The present invention provides a socket extension member for use with a square drive ratchet to close and open the valves on a Ratigan style oil field wellhead blow-out preventer. The extension member comprises a solid shaft portion connected to a first end portion with a square bore to matingly receive the square drive ratchet wrench and a second end portion connected to the shaft portion opposite of the first end portion with a circular bore and an interior of the circular bore being fashioned to matingly and engage the end of the wellhead Ratigan style blowout preventer valve.

### BRIEF DESCRIPTION OF THE DRAWINGS

FIG. 1 (a) is a front view of a socket wrench extension member according to the present invention.

FIG. 1 (b) is a top perspective view of a socket wrench extension member of FIG. 1 (a).

FIG. 1 (c) is a front perspective view of a socket wrench extension member of FIG. 1 (a).

FIG. 1 (d) is a front perspective view of a socket wrench extension member of FIG. 1 (a).

FIG. 1 (e) is an upside down perspective view of a socket wrench extension member of FIG. 1 (a).

FIG. 1 (f) is an upside down through 1 (g) are views of a socket wrench extension member of FIG. 1 (a).

FIG. 1 (g) is a bottom perspective view of socket wrench extension member of FIG. 1 (a).

FIG. 2 shows a typical wellhead blowout preventer (PRIOR ART).

FIG. 3 shows a typical wellhead blowout preventer (PRIOR ART).

FIG. 4 shows a typical wellhead blowout preventer (PRIOR ART).

FIG. 5 shows the socket wrench extension member of FIG. 1 (a) through 1 (g) with a typical wellhead blowout preventer.

FIG. 6 (a) is a front view of a socket wrench extension member according to a second embodiment of the present invention.

FIG. 6 (b) is a top perspective view of a socket wrench extension member according to a second embodiment of the present invention.

FIG. 6 (c) is a front perspective view of a socket wrench extension member according to a second embodiment of the present invention.

FIG. 6 (d) is a front perspective view of a socket wrench extension member according to a second embodiment of the present invention.

FIG. 6 (e) is an upside down perspective view of a socket wrench extension member according to a second embodiment of the present invention.

FIG. 6 (f) is an upside down through 1 (g) are views of a socket wrench extension member according to a second embodiment of the present invention.

FIG. 6 (g) is a bottom perspective view of socket wrench extension member according to a second embodiment of the present invention.

### DETAILED DESCRIPTION

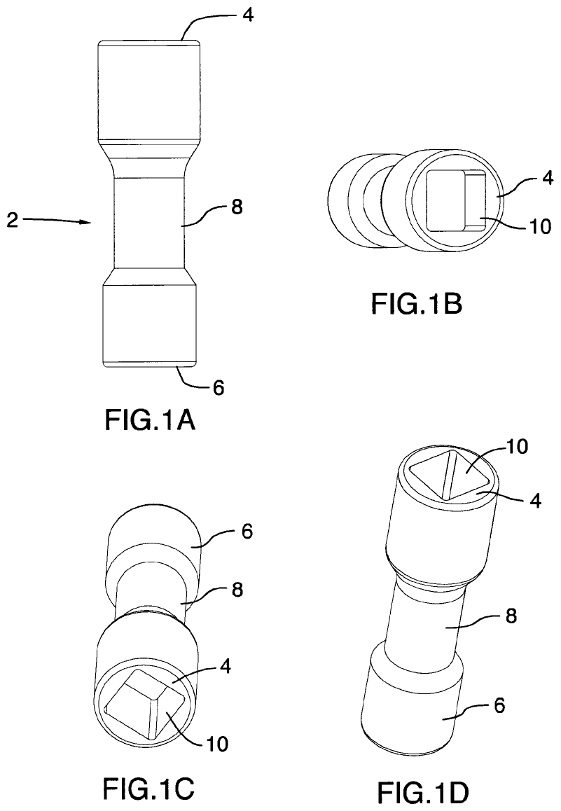

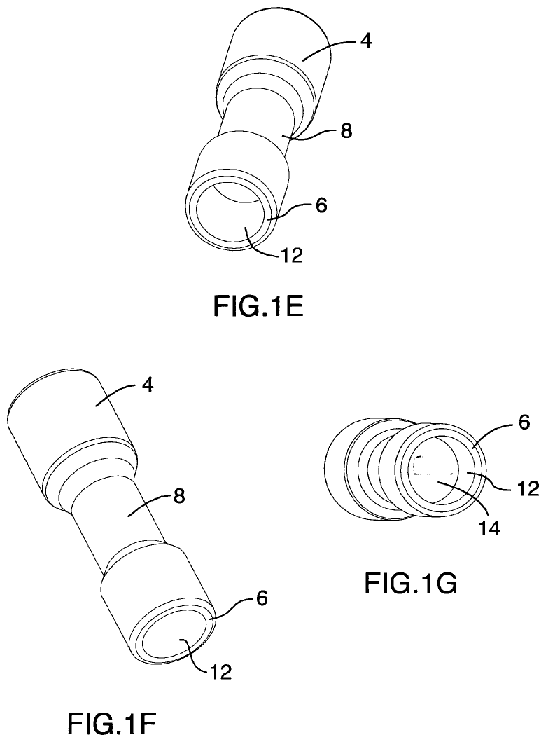

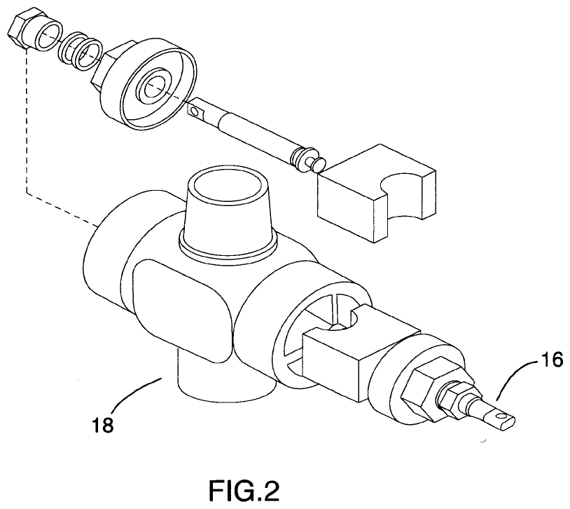

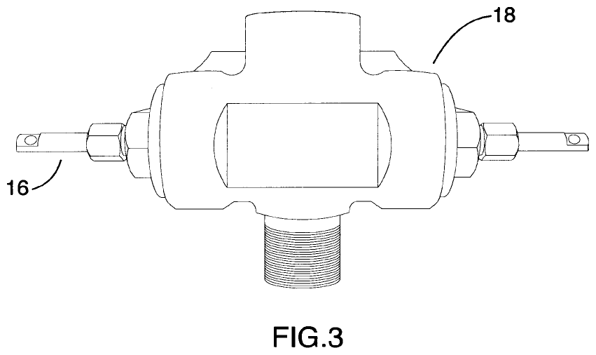

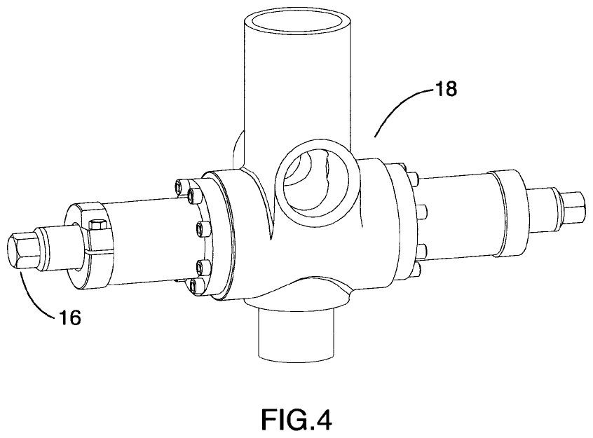

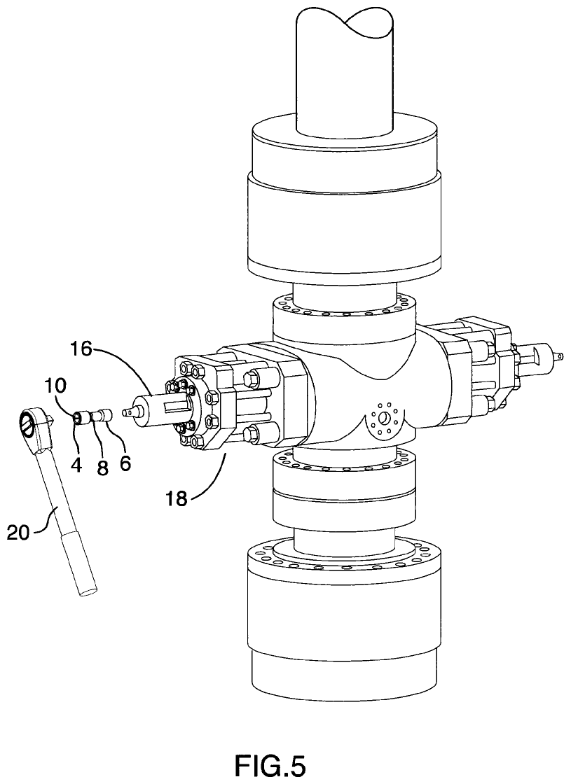

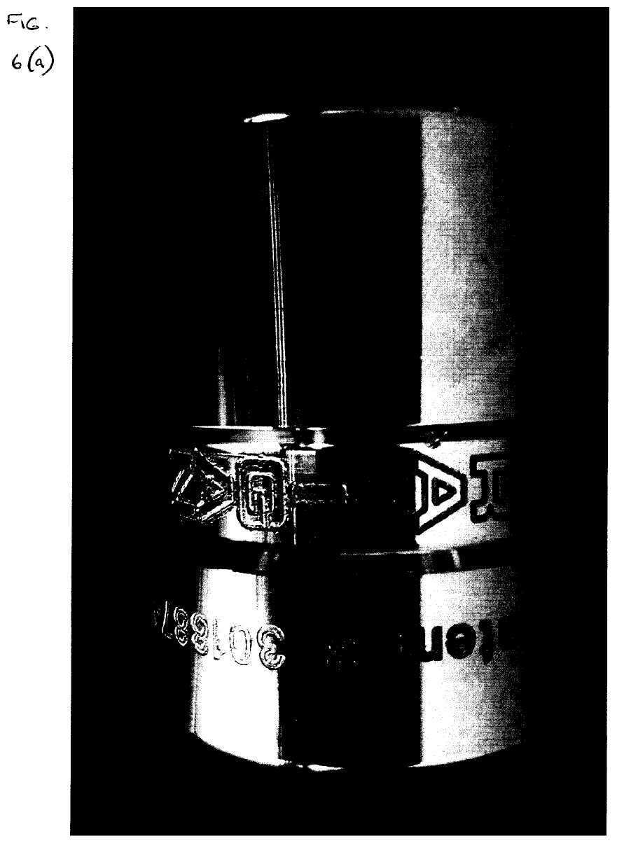

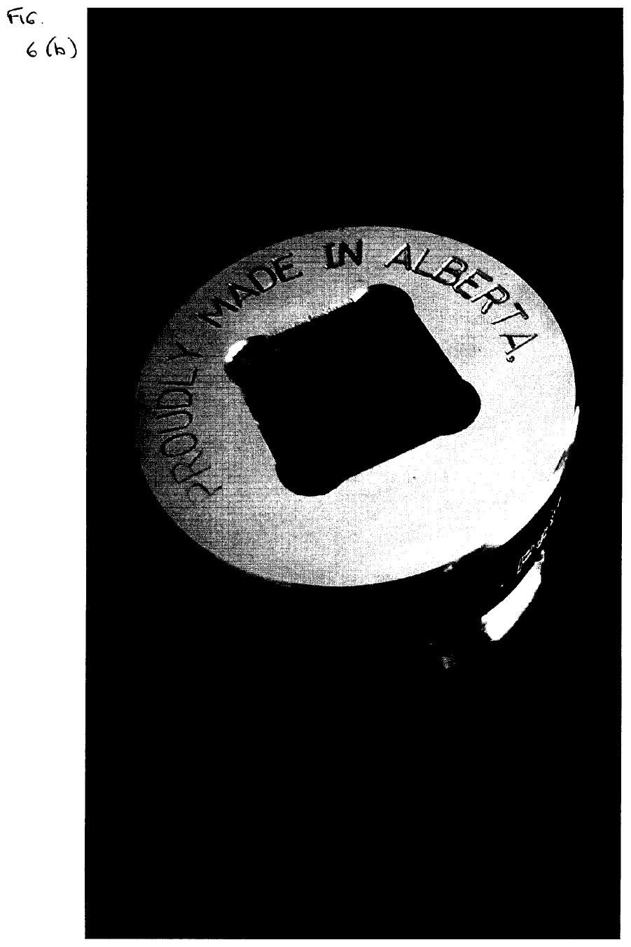

Referring to the Figures, there are shown views of a socket wrench extension member 2 according to the present invention. Referring to FIG. 1 (a), the socket wrench extension member 2 comprises a first end portion 4, a second end portion 6, and a shaft or extension portion 8 located between the first end portion 4 and the second end portion 6. Referring to FIG. 1 (b), the first end portion 4 is shown as having a square bore 10 for matingly receiving a square drive ratchet wrench 20 (as shown in FIG. 5). The preferred bore is for a ¾ inch square drive ratchet wrench 20. As shown in FIG. 1 (e), the second end portion 6 has a circular bore 12 to fit over the Ratigan wellhead blowout preventer valve 18 (as shown in FIG. 2), with the interior 14 of the circular bore 12 being fashioned to matingly engage the end 16 of the wellhead blowout preventer valve 18. As can be seen in FIG. 1 (g), in some cases the interior 14 is fashioned into a slot, while in other cases it could be fashioned into a hexagonal shape or some other shape, depending upon the shape of the end of the wellhead blowout preventer valve 18, to prevent the socket wrench extension from slipping during use.

In use, as can be seen in FIG. 5, a blowout preventer valve 18 has an end 16 of rectangular shape. The second end portion 6 of the socket wrench extension member 2 is placed over the end 16. The second end portion 6 has a circular bore 12 which is, in this case, fashioned in the shape of a slot so that the end 16 is matingly engaged and secured. The first end portion 4 of the socket wrench extension member 2 has a square bore 10 which is sized to receive a square drive ratchet wrench 20. By grabbing the handle of the square drive ratchet wrench 20 and turning the square drive ratchet wrench 20, the user is able to tighten or untighten the blowout preventer valve 18 as needed.

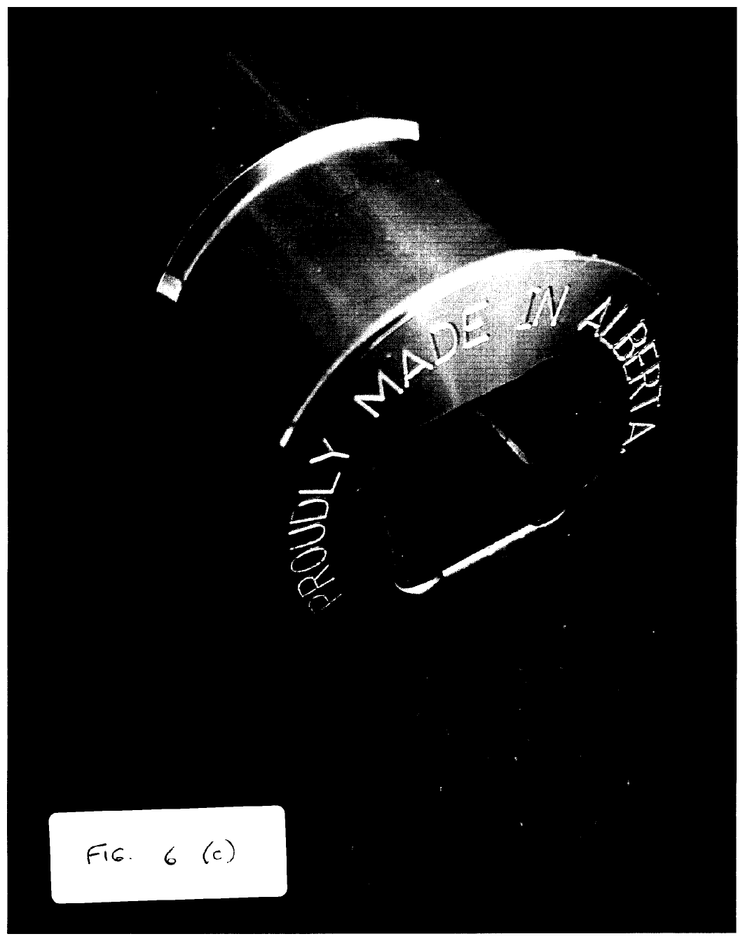

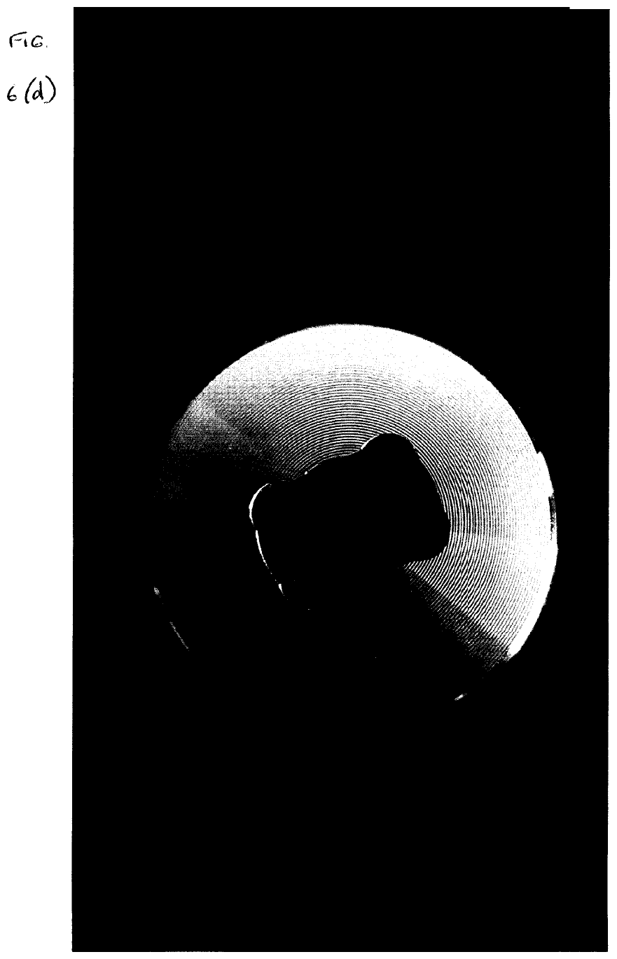

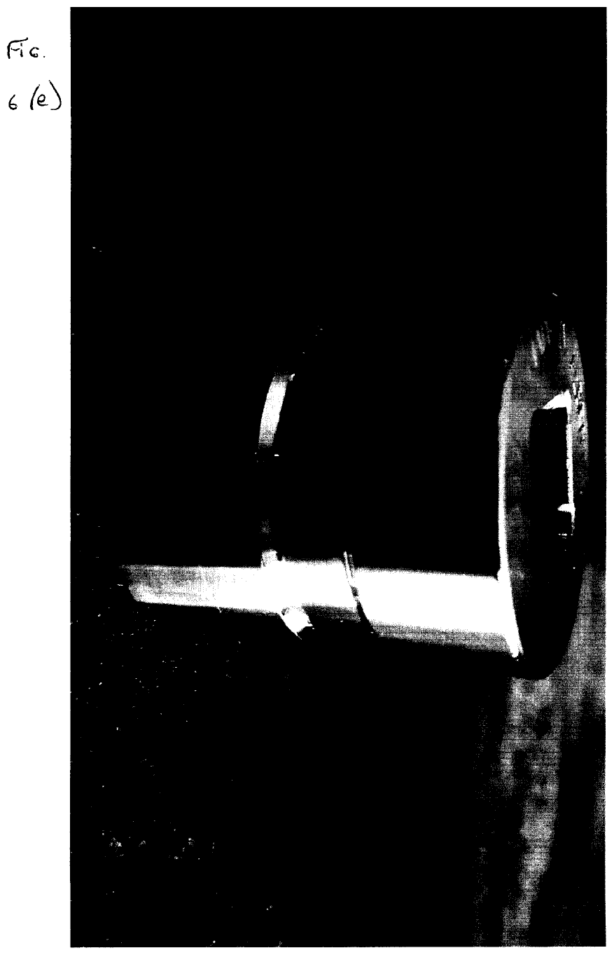

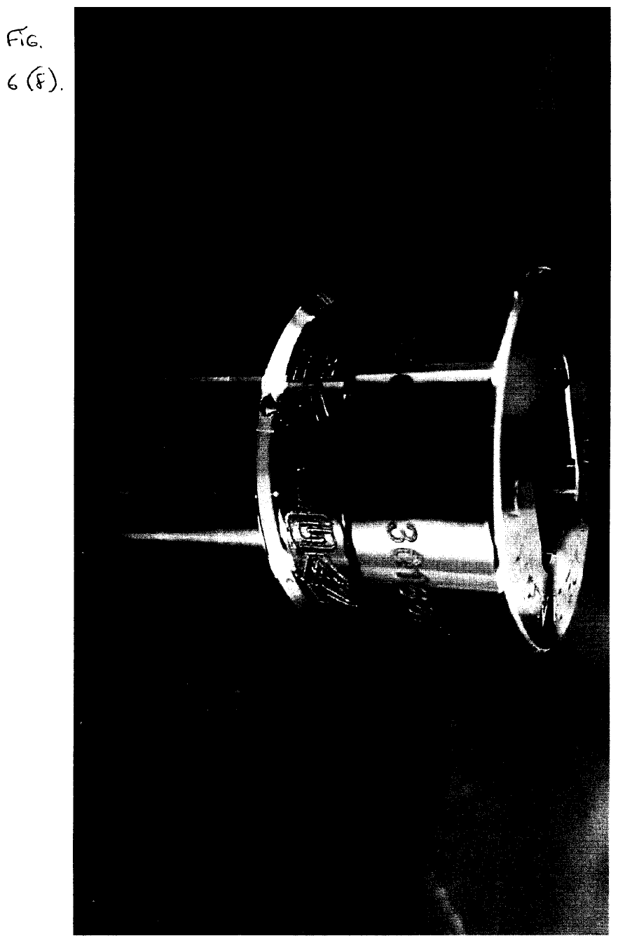

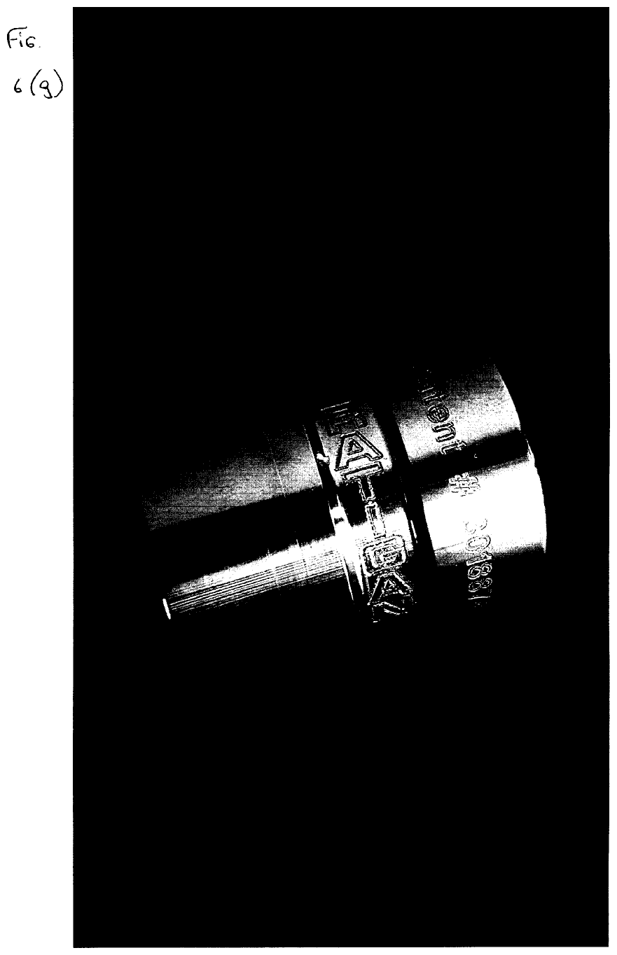

As can be seen in FIG. 6 (a) through (g), the size and configuration of the socket wrench extension member can be modified to suit different blowout preventer valves.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

The embodiments of the invention in which an exclusive property or privilege is claimed are defined as follows:

1. A socket wrench extension for use with a square drive ratchet comprising:
a shaft portion;
a first end portion including a polygonal bore for receiving a ratchet wrench;
a second end portion including a circular bore for receiving a
valve on an oil wellhead blow-out preventer, the interior of the circular bore being fashioned to matingly engage the end of the wellhead blowout prevent valve such that the square drive ratchet does not slip during use.

2. The socket wrench extension according to claim 1 wherein the polygonal bore is a square bore.

3. The socket wrench extension according to claim 2 wherein the diameter of the bore fits a ¾ inch square drive ratchet.
